(19) United States
(12) Patent Application Publication
(10) Pub. No.: US 2021/0311502 A1
(43) Pub. Date: Oct. 7, 2021

(54) Drone fleet management system

(71) Applicant: Inspire srI, Genova (IT)

(72) Inventor: Marco Ghio, Genova (IT)

(21) Appl. No.: 16/840,611

(22) Filed: Apr. 6, 2020

(51) Int. Cl. G05D 1/10; G05D 1/00; B64C 39/02

(52) U.S. Cl. CPC G05D 1/104; G05D 1/0027; B64C 2201/108; B64C 2201/146; B64C 2201/042; B64C 39/024

(57) ABSTRACT

A drone fleet management system includes a plurality of drones and a logistics support unit of the plurality of drones. The logistics support unit includes a landing area for the drones, a battery replacement area of the drones, and a take-off area for the drones. Moreover, the landing area includes a basin element having walls that converge toward a collection area communicating with the battery replacement area.

### FIELD OF THE INVENTION

The present invention relates to a drone fleet management system comprising a plurality of drones and a logistics support unit of the plurality of drones. The logistics support unit includes a landing area of the drones, a battery replacement area of the drones, and a take-off area for the drones.

### BACKGROUND OF THE INVENTION

In the field of known drone technology, one of the main problems is precision landing, i.e. the correct identification of a precise landing point.

An incorrect estimate of the landing point in fact causes not only a possible failure of the drone due to unwanted impacts, but also possible malfunctions of the service platforms, with the risk of obtaining temporary periods of inactivity of the platforms, which would not be able to perform the required services.

This issue is particularly relevant in the case of drone fleets, used for example for fire-fighting or video surveillance services, as in the case of patent application EP3463592, the content of which is to be considered an integral part of the present application.

In the state of the art there are two main types of solutions to obtain a precise landing.

A first type, preferably aimed at non-professional fields, is related to optical systems, which provides an object on board the drones that communicates with an optical device, so that the drone can be guided once it reaches the landing point.

The disadvantages of such systems are evident, considering that they are excessively affected by external conditions, such as lack of visibility given by weather events, fog, suspended particles, device dirt, etc.

The second solution is the most used in the professional field and relates to the use of radio signals, positioning systems such as GPS or the like.

Such systems measure the position of the object with respect to satellites but have induced errors and are generally not sub metric.

Expensive systems can improve GPS precision and also achieve centimetric precision.

However, these systems are affected by the configuration in which they operate, as any structures, buildings or trees can create disturbances that disturb the reception and processing of the signal.

In addition to the problem of precision landing, especially with regard to drone fleets, a particularly important parameter is the service time of each drone.

One of the requirements is to have a very low drone service time, that is, to have a few logistics support units that manage a large number of drones with limited time.

There is therefore an unmet need for state-of-the-art systems to make a drone management system that addresses the disadvantages above mentioned, allowing the landing of drones at a precise point.

### SUMMARY OF THE INVENTION

The present invention achieves the above objectives by providing a system as described above, wherein the landing area comprises a basin element, the walls of which converge towards a collection area communicating with the battery replacement area.

The presence of a basin element allows obtaining a precise landing point of the drone, that is, the collection area, expanding the landing area, thanks to the flaring of the walls of the basin element.

The size of the collection area is reduced, increasing the size of the landing gear.

Such configuration also has a further advantage in that, once the drone has landed, it does not require any intervention by auxiliary means adapted to the handling of the drone, such as for example the grabbing bars that are commonly used in state-of-the-art systems.

All drones landing in the landing area will then be transported naturally, thanks to gravity, to the collection area.

According to a preferred embodiment, each drone comprises a cage configured to at least partially surround the outer surface of the drone.

The cage works synergistically with the basin element, as it protects the drone after it lands inside the basin element, avoiding damage, even if the drone rolls or slips along the walls of the basin element.

The presence of the cage also protects the drone from collisions with other drones, both in flight and in the landing area, or with objects, even in case of landing outside the landing area.

The cage may, however, be an impediment to certain drone activities, such as fire-fighting fluid delivery or video surveillance and monitoring activities.

For this reason, according to a refinement, the cage is made up of at least two overlapping parts, such that the two parts switch from a retracted condition, in which the two parts are overlapped at least partly with each other, to an extracted condition, in which at least one of the two parts surrounds, at least partly, the lower part of the drone.

In an extracted condition, the lower part of the drone is surrounded at least partly since it is possible to expect that does not entirely surround the external surface of the drone, but forms an external shell in conjunction with the bottom of the battery, as it will be illustrated in the following.

A possible embodiment of such a cage will be illustrated below, but the advantages are already clear now, as the cage can be activated in an extracted condition of the two parts in the event of a possible collision, while it can be activated in a retracted condition of the two parts, in the event that the cage causes impediment to drone activities or its storage.

According to an embodiment, detecting means for the orientation of the drone are provided.

Such means may for example consist of RFID tags or the like on the drone which communicate with reading systems on board the logistics support unit.

Since the drone battery is generally positioned below the drones themselves, in the battery replacement step the drone must be oriented so that the battery is immediately detectable by the battery replacement means such as a robotic arm.

The presence of detecting means for the orientation of drones is therefore particularly advantageous to facilitate the correct removal of the battery.

The battery removal step is a critical moment during the drone management procedure, as it involves the disconnection of the electric current that keeps the drone on.

The replacement battery coupling allows a restarting of the drone, however requiring a not negligible restart period of the operating system that manages the drone.

In order to reduce the service time of drone management, it would be preferable to maintain the drone's electrical contact, so that it should never be switched off.

To meet this purpose, an embodiment of the invention provides that the logistics support unit comprises drone grabbing means, which in turn comprise a first terminal adapted to cooperate with a corresponding second terminal provided on drones.

The connection between the first terminal and the second terminal establishes an electrical connection between the drone and the grabbing means.

As will be seen later, the grabbing means, connected to the logistics support unit, guarantee the electric continuity of the drone.

Advantageously, the basin element is composed of a plurality of modular elements, configured to switch from a folded condition to a deployed condition.

In the folded condition the modular elements are overlapped on each other, while in the deployed condition the modular elements are positioned as to form the basin element.

The advantages of such a configuration are evident.

Firstly, the size of the drone logistics support unit and its portability are reduced.

Secondly, despite the reduced size of the logistics support unit, a large landing area is obtained, capable of covering a large area where drones can rest.

For situations involving a limited number of drones, the present invention makes a logistics support unit particularly limited in size, in which the collection area, the battery replacement area and the take-off area coincide.

As will be most apparent from the illustration of some embodiments, according to this configuration, the drone lands in the landing area, moves into the collection area, replaces the battery and takes off again.

All procedures are carried out in the collection area, the drone lands and takes off in a very short time.

As an alternative to the above-described variant, the battery replacement area comprises a conveyor belt adapted to move the drone from the collection area to the take-off area.

This configuration is particularly advantageous in the case of the presence of a large number of drones.

In fact, according to the dictates of Little's law, which establishes that the productivity and efficiency of a process depends on the number of objects (in this case drones) subjected to the process and the duration of the process.

If, as in this case, the process time, that is, the service time relative to battery replacement, is fixed, the higher the number of drones that the system can process, the greater the efficiency of the system.

The configuration described above thus allows for the “accumulation” of drones in the collection area, so that they can be seamlessly processed.

In view of the advantages just described relating to the drone management system of the present invention, the present invention also relates to a drone-type radio-controlled aircraft or the like, typically an unmanned aircraft, comprising one or more propulsion propellers and a battery mounted below the body of the aircraft.

The aircraft object of the present invention further provides a cage configured to surround at least partly the outer surface of the aircraft.

Advantageously, the cage is made up of at least two overlapping parts, such that the two parts switch from a retracted condition, in which the two parts are overlapped at least partly with each other, to an extracted condition, in which at least one of the two parts surrounds the lower part of the aircraft.

As discussed previously, the cage does not have advantageous aspects exclusively in combination with a certain embodiment of the logistics support unit, but avoids damage to the drone in the event of collisions, without creating an impediment to the activity that the drone must perform.

Finally, according to one embodiment of the aircraft object of the present invention, there are detecting means for the orientation of the aircraft.

### BRIEF DESCRIPTION OF THE DRAWINGS

These and other features and advantages of the present invention will become clearer from the following description of some exemplary embodiments illustrated in the attached drawings wherein:

FIGS. 1a-1f illustrate different views of a possible embodiment of an aircraft according to the present invention;

FIG. 2 illustrates a perspective view of a logistics support unit in a system object according to present invention;

FIG. 3 illustrates a concept diagram of a logistics support unit in a system object according to present invention.

### DETAILED DESCRIPTION OF EMBODIMENTS OF THE INVENTION

The figures enclosed herein illustrate only some possible embodiment of a drone management system according to the present invention in order to better understand its advantages and features.

Such embodiments are, therefore, only provided for illustrative purposes only and not to be considered as limiting the inventive concept of the present invention, that is, to create a system that allows obtaining a precise landing point for drones, as well as a system that allows managing the drones efficiently, maintaining a high degree of continuity in the activities carried out by the drones.

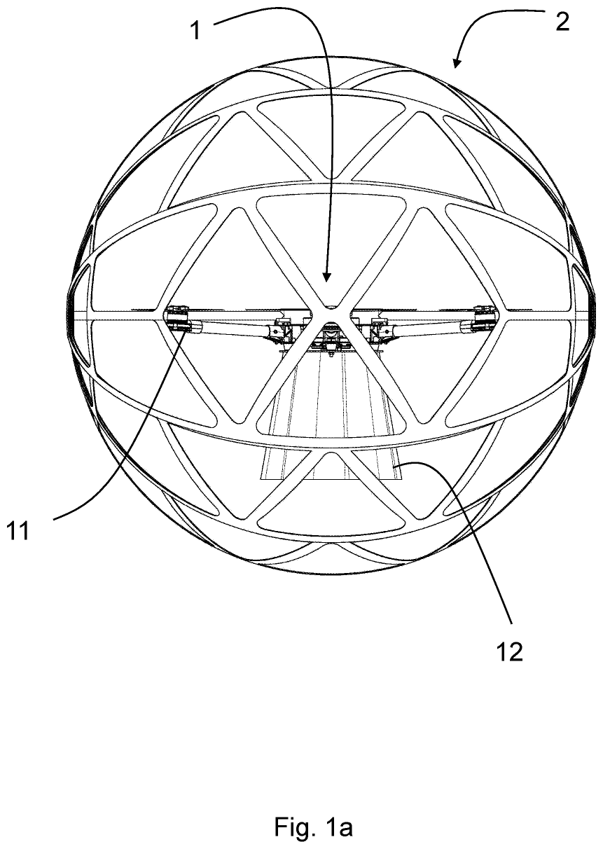

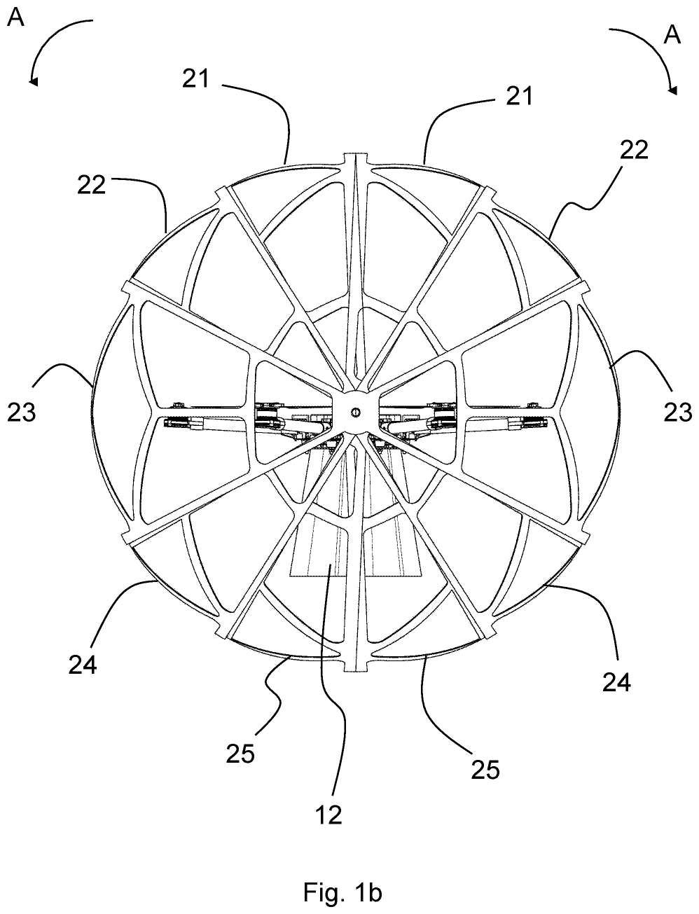

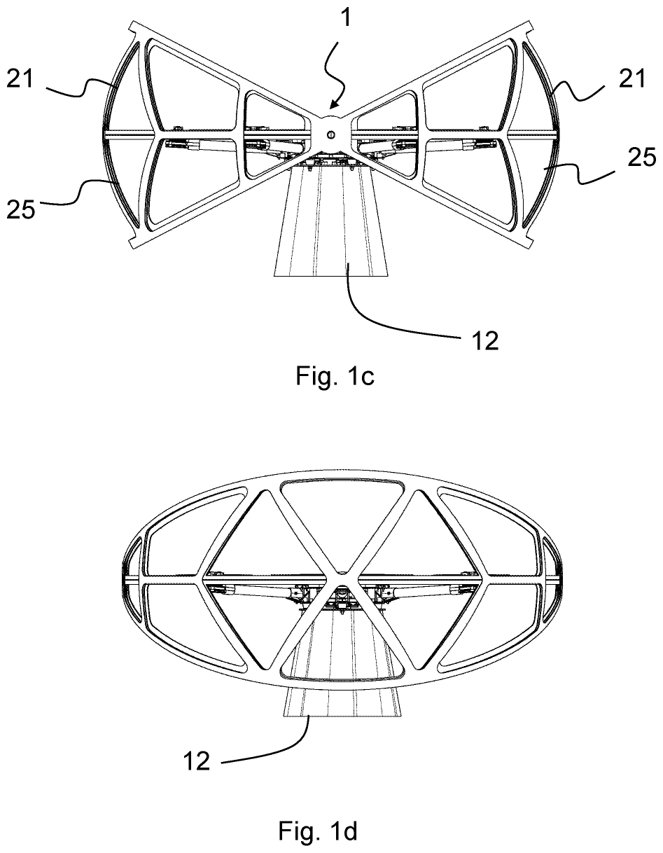

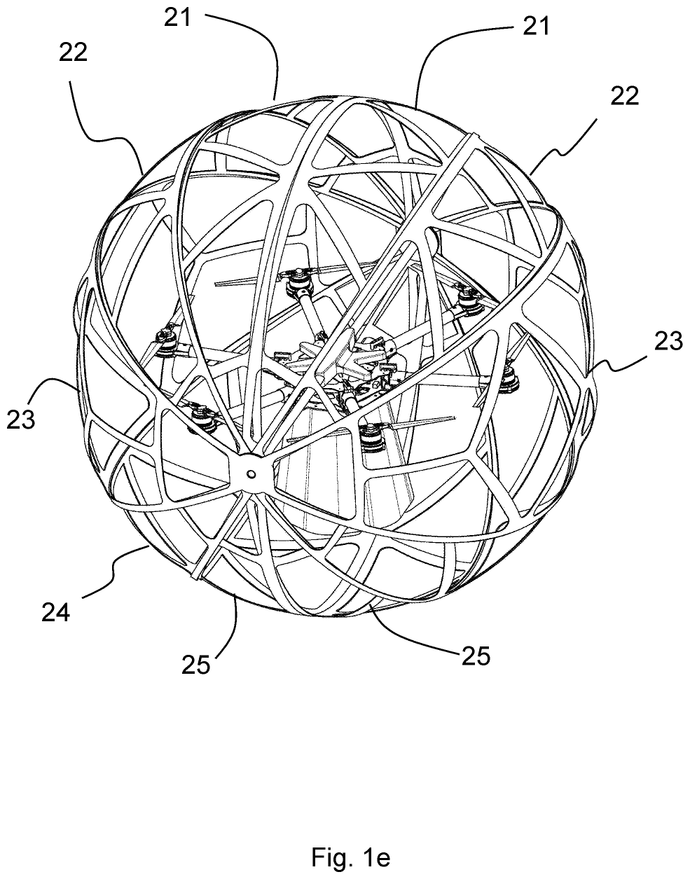

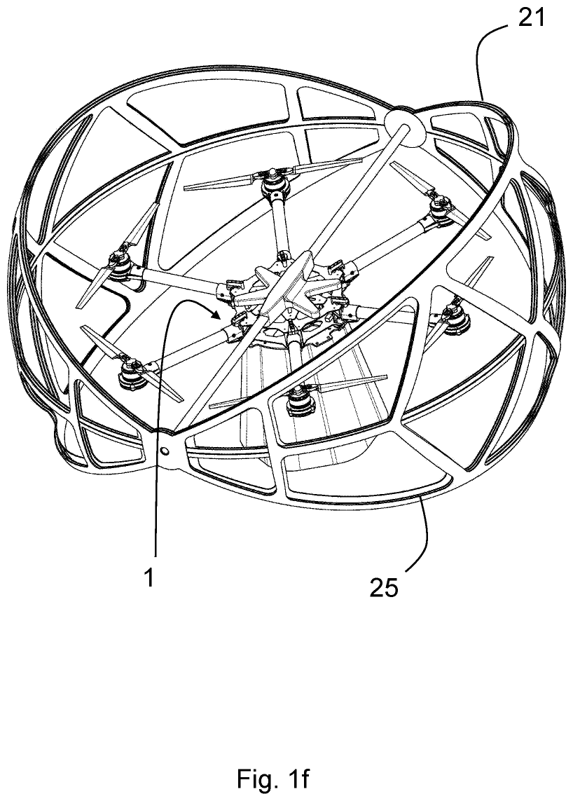

With particular reference to FIGS. 1a-1f, there are illustrated a few views of an aircraft, in particular of drone 1, according to the present invention.

The drone 1 can be made in any of the ways known in the art and in particular has propulsion propellers 11 and a battery 12, placed below the body of the drone 1.

In the accompanying figures, drone 1 has a battery 12 placed below thereto, but any component other than the battery may be provided.

For example, in applications related to fire-fighting operations, a fire-fighting liquid reservoir may be provided, as illustrated in patent application EP3463592.

The drone 1 of the present invention further has a cage 2 adapted to surround the external surface of the drone 1.

In particular, the cage 2 has two or more overlapping parts with each other, such that such parts go from a retracted condition, shown in FIGS. 1c, 1d, 1f in which the parts overlap at least partly with each other, to an extracted condition, shown in FIGS. 1a, 1b, 1d in which at least one of the parts surrounds the lower part of the drone 1.

FIG. 1b illustrates a side view of drone 1 and shows that cage 2 is divided into two symmetrical halves, one front and one rear, with reference to the forward and rear direction of drone 1.

Each half is divided into five parts, 21, 22, 23, 24 and 25.

In the extracted condition, shown in FIGS. 1a, 1b, 1d, such parts are not overlapping with each other and surround entirely the drone 1 and in particular the lower part thereof, with the battery 12.

In the retracted condition, shown in FIGS. 1c, 1d, 1f, the parts 21 and 25 overlap respectively with the parts 22 and 24 in the direction indicated by arrow A, as in turn the parts 21, 22, 24 and 25 overlap entirely with the part 23.

In particular the most protruding parts, i.e. the parts 21 and 25 remain external to the innermost parts 23, with the parts 22 and 24 in the intermediate layer.

With particular reference to FIG. 1b, the parts 25 of both halves, in the extracted condition, cover the battery 12.

According to one embodiment, it is possible to provide that the bottom of the battery 12 acts as the cage 2, i.e. the parts 25 in the extracted condition, would abut laterally with the battery 12.

According to such a configuration, the bottom of the drone-sphere assembly it would consist of the bottom of the battery 12, such that the battery 12 is always accessible, with the cage 2 in an extracted condition and in a retracted condition.

Regardless of the embodiment, in retracted condition, the lateral parts, i.e. the parts 23 remain fixed to protect the drone 1, so as to protect the propulsion propellers 11 laterally.

Handling of the parts 21-25 is preferably achieved through servomotors on board the drone, the activation of which can be either automatic or manually managed, by an operator through a remote unit.

Preferably the cage 2 is in the extracted condition during the flight of the drone 1 and in the landing step, as will be described later, while at least during the take-off step and during the battery replacement step, the cage 2 is in the retracted condition.

In the case of the variant described above, i.e. in the case in which the parts 25, in an extracted condition, abut to the bottom of the battery 12, it will not be necessary to activate the cage 2 in a retracted condition for the replacement of the battery 12 and the take-off operations.

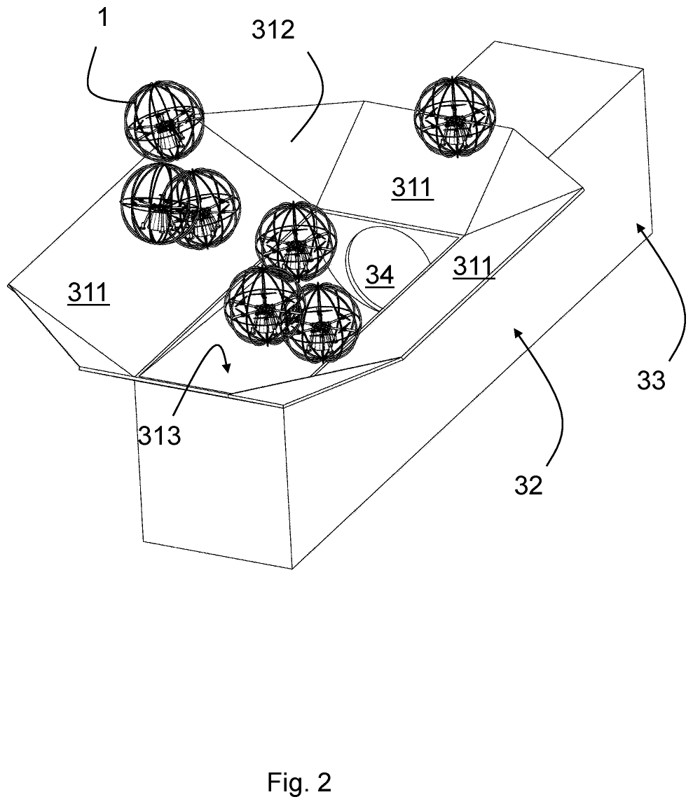

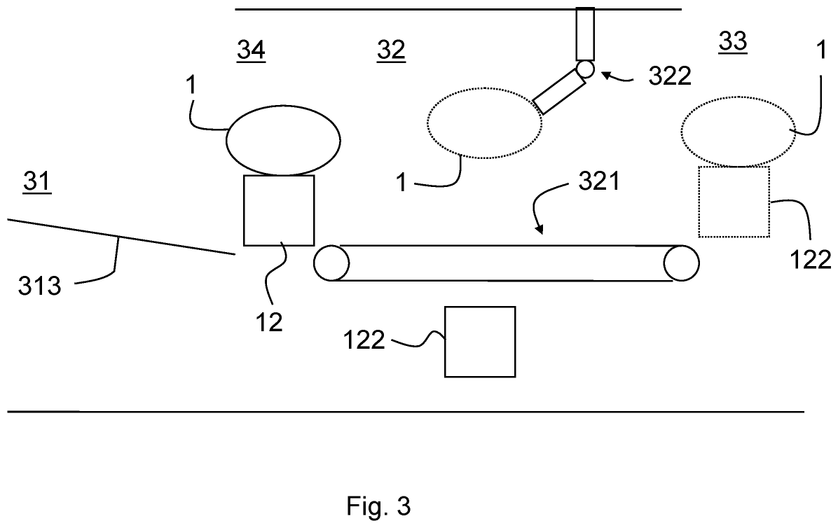

FIGS. 2 and 3 illustrate an embodiment of a drone management system according to the present invention, in particular of the logistics support unit 3.

The logistics support unit 3 comprises a landing area 31 of the drones, a battery replacement area 32, and a take-off area 33.

The battery replacement area 32, may be any area in which processing is performed on drones, whether it is battery replacement and/or loading/unloading of a particular instrumentation provided on board the drone.

The landing area 31 comprises a basin element having the walls converging towards a collection area 34, communicating with the battery replacement area 32.

With particular reference to FIG. 2, the basin element provides four side walls 311, joined in pairs through a junction element 312.

As can be seen from FIGS. 2 and 3, all side walls 311 converge toward a slide 313, connecting to the collection area 34.

Preferably, the side walls 311 have hinges at the base, so as to be able to oscillate, to close in the direction of the slide 313 and decrease the size of the logistics support unit 3.

It can be seen that the side walls 311, in closed condition, overlap at the slide 313.

The junction members 312, in the closed condition of the side walls 311, retract, whereby they either fit between one wall and the other, or fall within the thickness of the side walls, or alternatively are made of a sufficiently yielding material, so as to bend.

Regardless of the configuration, the drones 1 land at the landing area 31.

Preferably, the drones 1 have the cage 2 in a closed configuration, so as to assume the external shape of a sphere, as illustrated in FIG. 2.

The sphere shape enables drones 1 to roll/shift/slide alongside walls 311 once they have landed and come into contact with the basin element.

During the landing step each drone 1 rolls towards the collection area 34 through the slide 313: the logistics support unit 3 functions as a sort of “funnel” that not only converges the drones 1 towards the collection area 34, but aligns the drones 1 at the collection area 34, so that one drone at a time can pass.

For this reason, preferably the collection area 34 comprises an opening that is slightly larger than the diameter of the sphere made by the cage 2.

As a result, a tail of drones will form waiting to enter the battery replacement area 32.

The battery replacement procedure is described with reference to FIG. 3, wherein a schematic section of the battery replacement area 32 is illustrated.

It can be seen from the following description that the automatisms of area 32 are controlled by a central control unit, remote or on board the logistics support unit 3, which monitors and commands the entire procedure.

Such a central control unit may also command the opening/closing of the side walls 311, as well as overseeing the guidance of the drones 1.

It is also seen that a user can intervene manually, through remote controls, both on the drones handling and on the procedure described.

The drone 1 is located in collection area 34, communicating with the battery replacement area 32.

Before replacing the battery 12, the drone 1 must be positioned with the battery 12 oriented below the bottom of the battery replacement area 32.

For this reason, the drone 1 has orientation detecting means, which communicate with additional means on board the logistics support unit 3, so that the drone 1 is positioned with the battery 12 facing downwards.

The rotation of the drone 1 to obtain the correct positioning can be carried out either by the conveyor belt 321, or by the gripping arm 322, which will be described later.

Alternatively, forced orientation through mechanical constraints can be provided.

For example, it is possible to provide that the mode of the sphere of the cage 2 is made so that the cage 2 arrives in the collection area 32 always in the same position.

It may be possible to think of one or more pins in the cage 2 that are embedded in dedicated constraints at the collection area 34.

In any case, once the drone 1 is with the battery 12 placed below thereto, the cage 2 opens, in order to access the battery 12.

As anticipated, in the case in which the cage 2 completely surrounds the drone 1, it is necessary to open, i.e. place the cage 2 in a retracted condition to replace the battery 12.

In the case in which the cage, in an extracted condition, only partly surrounds the drone 1, it will not be necessary to open the cage, since, as previously discussed, the battery 12, will be accessible for replacement.

The conveyor belt 311 picks up the drone 1 and drags it into the area 323 where the battery 12 can be replaced with a replacement battery 122.

The battery can be replaced in any of the ways known in the art.

When detaching the battery 12, a gripping arm 322 is preferably provided that connects to the drone 1, in a suitable connection seat, so as to establish an electrical contact and ensure electrical continuity and provide the power supply to the drone 1 necessary so that it does not turn off.

The gripping arm 322 may also be responsible for replacing the battery 12.

The presence of the gripping arm 322 is not essential: it is in fact possible to provide feeding means for the drone 1 made, for example, thanks to the contact between the drone 1 and the conveyor belt 321.

In this case, sliding contacts could be made that ensure electrical continuity between drone 1 and conveyor belt 321.

Alternatively, or in conjunction, it is possible to provide umbilical system whereby the contact point of the gripping arm there are pressure electrical contacts which guarantee electrical continuity and a connection to an external power supply during the service steps. The cage will therefore be provided with an electrical connection system between the external edge thereof where the connection to the pressure contacts takes place and the power supply system of the drone itself.

The conveyor belt 321 may consist of two peripheral belts on which the drone rests, so as to provide a central channel to allow for the correct replacement of the battery 12: the battery 12 is disconnected and falls downwards, the drone continues its path and subsequently the replacement battery 122 is mounted, as drawn with dotted lines in FIG. 3.

Once the replacement battery 122 is mounted, the drone 1 is dragged to the take-off area 33, where it can restart to perform the required services.

Preferably, the take-off area 33 is open, so that the drone 1 can rise vertically in flight.

Finally, it is specified that, advantageously, the logistics support unit presents the size of a standard container, so as to be easily transported.

Logistics support unit 3, in the transport step, can also contain the drone fleet necessary to carry out the requested service.

While the invention can be changed according to a number of modifications and alternative constructions, some preferred embodiments have been shown in the drawings and described in detail.

It should be understood, however, that there is no intention of limiting the invention to the specific illustrated embodiments but, on the contrary, all modifications, alternative constructions, and equivalents fall within the scope of the invention as defined in the claims.

The use of “for example”, “etc.”, “or” refers to non-exclusive non-limiting alternatives, unless otherwise stated.

The use of “including” means “including but not limited to”, unless otherwise stated.

The invention claimed is:

1. A drone fleet management system comprising:
a plurality of drones; and
a logistics support unit of said plurality of drones, said logistics support unit comprising a landing area for said drones, a battery replacement area of said drones, and a take-off area of said drones,
wherein said landing area comprises a basin element having walls that converge toward a collection area communicating with said battery replacement area.

2. The drone fleet management system according to claim 1, wherein each drone comprises a cage configured to surround at least partly an outer surface of said drone.

3. The drone fleet management system according to claim 2, wherein said cage comprises two overlapping parts arranged to switch from a retracted condition, wherein the two overlapping parts are overlapping at least partly with each other, to an extracted condition, wherein at least one of the two parts surrounds at least partly a lower part of the drone.

4. The drone fleet management system according to claim 1, further comprising an orientation detector for said drones.

5. The drone fleet management system according to claim 1,
wherein said logistics support unit comprises a grabbing system of one of the drones, said grabbing system comprising a first terminal adapted to cooperate with a corresponding second terminal provided on the one of the drones, and
wherein a connection between the first terminal and the second terminal establishes an electrical connection between the one of the drones and said grabbing system.

6. The drone fleet management system according to claim 1, wherein said basin element comprises a plurality of modular elements configured as to switch from a folded condition to a deployed condition, and wherein, in the folded condition, said modular elements are overlapped on each other, and in the deployed condition the modular elements are positioned in order to form said basin element.

7. The drone fleet management system according to claim 1, wherein said collection area, said battery replacement area, and said take-off area coincide.

8. The drone fleet management system according to claim 1, wherein said battery replacement area comprises a conveyor belt adapted to move the drones from the collection area to the take-off area.

9. A radio-controlled unmanned aircraft comprising:
one or more propulsion propellers;
a battery mounted below a body of said unmanned aircraft; and
a cage configured to surround at least partly an outer surface of said unmanned aircraft,
wherein said cage comprises two overlapping parts arranged to switch from a retracted condition, wherein the two overlapping parts are overlapping at least partly with each other, to an extracted condition, wherein at least one of the two overlapping parts surrounds at least partly a lower part of said unmanned aircraft.

10. The radio-controlled aircraft according to claim 9, further comprising an orientation detector for an orientation of said unmanned aircraft.
